(19) United States
(12) Patent Application Publication
(10) Pub. No.: US 2017/0159885 A1
(43) Pub. Date: Jun. 8, 2017

(54) AEROSOL CAN ADAPTOR METHOD OF USE

(71) Applicant: Air Liquide Healthcare America Corporation, Houston, TX (US)

(72) Inventors: Spencer PHILPOT, Philadelphia, PA (US); Ric UPHAUS, Troy, AL (US)

(21) Appl. No.: 15/368,017

(22) Filed: Dec. 2, 2016

Related U.S. Application Data
(60) Provisional application No. 62/263,267, filed on Dec. 4, 2015.

(51) Int. Cl. F17C 13/04; B65D 83/20; B65D 83/44

(52) U.S. Cl. CPC F17C 13/04; B65D 83/44; B65D 83/207; B65D 83/205; F17C 2205/0332

(57) ABSTRACT

A method of adapting a threaded connection to an aerosol can, including providing a lower fitting, an upper fitting including a male thread, and a seating radius configured to conform with a curled lip of the aerosol can, a crimp ring, configured to rest between the lower crimp ring seating surface and the upper crimp ring seating surface, inserting the lower fitting into the crimp ring and the upper fitting, thereby forming an adaptor assembly, inserting the adaptor assembly, lower fitting first, into the aerosol can, the aerosol can comprising an inner surface, pulling the lower fitting through the upper fitting, thereby compressing the crimp ring in the axial direction while simultaneously expanding in the radial direction, thereby making contact with the inner surface and fixedly installing the adaptor assembly in the aerosol can.

### CROSS REFERENCE TO RELATED APPLICATIONS

This application claims the benefit of priority under 35 U.S.C. §119 (a) and (b) to U.S. Patent Application No. 62/263,267 filed Dec. 4, 2015, the entire contents of which are incorporated herein by reference.

### BACKGROUND

A revision to regulations allows for refrigerant 134a to be filled into small, easily portable aerosol cans, provided the aerosol can meets the minimum requirements outlined in the shipping regulations. Previously, R134a has been filled into 1 liter steel containers that have CGA-600 valves. The equipment that the aerosol can connects to has been designed and built to accommodate an aerosol can with a CGA-600 valve. No CGA-600 valve currently exists that can connect to an aerosol can. A need now exists in the industry for such an aerosol can CGA-600 valve adaptor.

### SUMMARY

A method of adapting a threaded connection to an aerosol can, including providing a lower fitting, an upper fitting including a male thread, and a seating radius configured to conform with a curled lip of the aerosol can, a crimp ring, configured to rest between the lower crimp ring seating surface and the upper crimp ring seating surface, inserting the lower fitting into the crimp ring and the upper fitting, thereby forming an adaptor assembly, inserting the adaptor assembly, lower fitting first, into the aerosol can, the aerosol can comprising an inner surface, pulling the lower fitting through the upper fitting, thereby compressing the crimp ring in the axial direction while simultaneously expanding in the radial direction, thereby making contact with the inner surface and fixedly installing the adaptor assembly in the aerosol can.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a cut-away schematic representation of an aerosol can as known in the art.

FIG. 2a is a schematic representation of the lower fitting.

FIG. 2b is a schematic representation of the lower fitting illustrating the separation of the pull-ring.

FIG. 3a is a schematic representation of the upper fitting.

FIG. 3b is an enlarged view of the upper fitting illustrating the seating radius and the third o-ring groove.

FIG. 4 is a schematic representation of the crimp ring.

FIG. 5 is a schematic representation of the 2^{nd} o-ring retainer.

FIG. 6 is a schematic representation of the upper fitting, the lower fitting and the crimp ring assembly, before installation.

FIG. 7 is a schematic representation of the upper fitting, the lower fitting the crimp ring assembly and the assembly tool, inserted into an aerosol can, before installation.

FIG. 8 is a schematic representation of the upper fitting, the lower fitting the crimp ring assembly and the assembly tool, inserted into an aerosol can, during installation, illustrating the deformation of the crimp ring.

FIG. 9 is a schematic representation of the upper fitting, the lower fitting the crimp ring assembly and the assembly tool, inserted into an aerosol can, during installation, illustrating the separation of the pull-ring and assembly tool.

FIG. 10 is a schematic representation of the adaptor assembly after installation in an aerosol can, illustrating the first o-ring and the retaining ring.

FIG. 11 is a schematic representation of the adaptor assembly after installation, illustrating the second o-ring.

FIG. 12 is a schematic representation of the aerosol can and adaptor assembly after assembly, illustrating the third o-ring.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure

### ELEMENT LIST

100=aerosol can

101=curled lip (of aerosol can)

102=inner surface (of aerosol can)

200=lower fitting

200a=lower fitting (without pull ring)

201=central axial opening (of lower fitting)

202=pin valve

203=lower travel stop

204=lower crimp ring seating surface

205=pull ring

206=exterior first o-ring groove

207=second o-ring seat

208=inner retaining ring groove

300=upper fitting

301=male thread (on upper fitting)

302=seating radius

303=upper travel stop

304=upper crimp ring seating surface

305=interior first o-ring sealing surface

306=outer retaining ring groove

307=retaining ring compression taper

308=third o-ring groove

400=crimp ring

500=second o-ring retainer

600=assembly tool

701=first o-ring

702=second o-ring

703=retaining ring

704=third o-ring

As used herein, the term “pin valve” refers to any type of small spring assisted poppet valve. Typically, pin valves have externally threaded hollow cylindrical tubes. In the center of the exterior end is a metal pin pointing along the axis of the tube. The pins end is approximately flush with the proximal end of the valve body. In use, the pressure on the distal end keeps the poppet valve seated, and blocks gas flow from inside the aerosol can. If flow from within the aerosol can is desired, force is applied to the pin, which compresses the spring that holds the poppet valve shut. As the poppet valve comes unseated, pressurized gas may flow out of the pin valve. (Typical examples of such pin valves would be Shrader valves (also known as American valves), or Presta valves (also known as Sclaverand valve or French valve)

As used herein, the term “aerosol can” refers to typical crimped construction tinplate or aluminum containers, while other construction materials such as polymers may be used. These may be 1-piece, 2-piece, or 3-piece construction. These may also be referred to as “inner receptacles”. It is also understood, that the present invention may applied to other pressurized cylinders if needed.

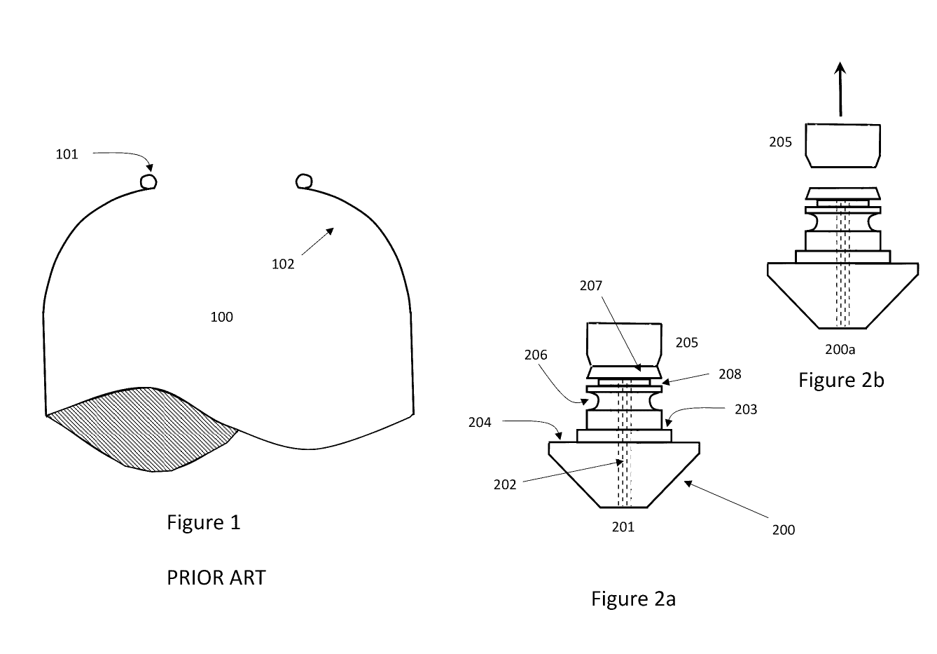

Turning to FIG. 1, a typical aerosol can 100 is presented. The aerosol can 100 has a curled lip 101 and an inner surface 102. The aerosol can 100 may contain R134a.

Turning to FIG. 2a, a lower fitting 200 including a central, axial opening 201, including a pin valve 202, a lower travel stop 203, and a lower crimp ring seating surface 204 is presented. The pin valve 202 may be a Schrader valve, or American valve. The pin valve 202 may be a Presta valve, Sclaverand valve, or French valve. The lower fitting 200 may include an exterior first o-ring groove 206, configured to mate with a first o-ring 701. The lower fitting 200 may include a second o-ring seat 207, configured to mate with a second o-ring 702. The lower fitting 200 may include an inner retaining ring groove 208, configured to mate with a retaining ring 703.

The lower fitting 200 may also include a pull-ring 205 which is configured to accept an assembly tool 600, and which is configured to shear upon completion of assembly, and separate from the lower fitting 200a, as indicated in FIG. 2b.

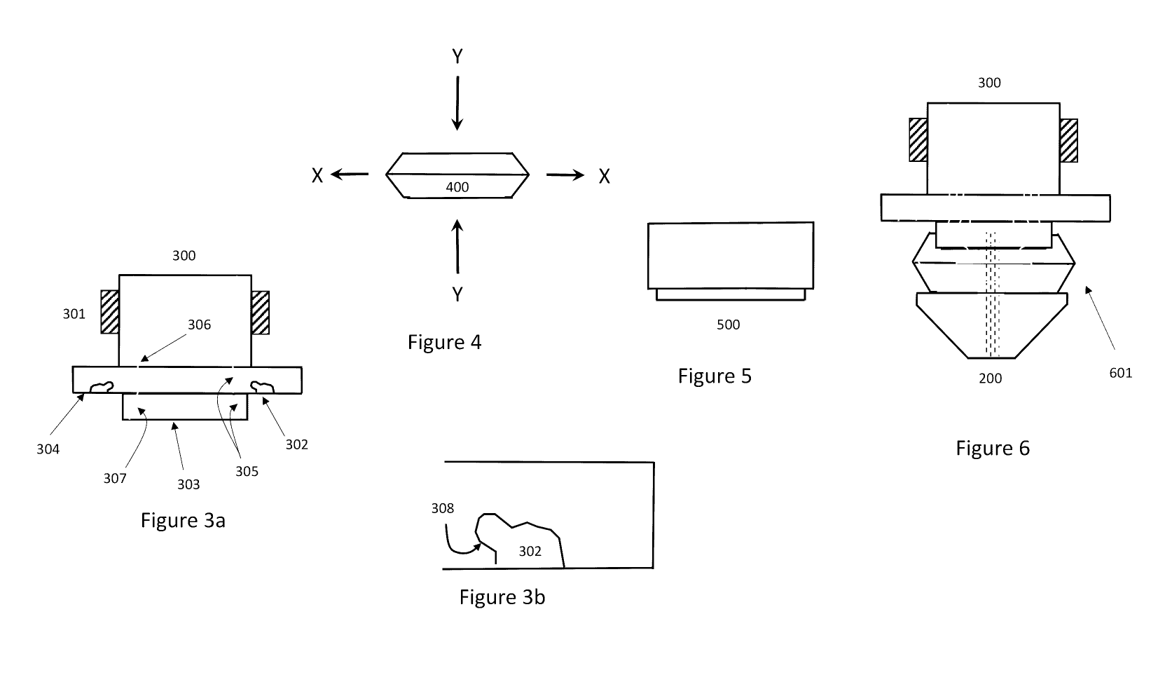

Turning to FIG. 3a, an upper fitting 300 including a male thread 301, a seating radius 302 configured to conform with a curled lip 101 of the aerosol can 100, an upper travel stop 303, configured to contact the lower travel stop 203 during assembly, and an upper crimp ring seating surface 304 is provided. The male thread 301 may be compatible with a female CGA-600 connection. The upper fitting 300 may include an interior first o-ring sealing surface 305 configured to seal against the first o-ring 701 during assembly. The upper fitting 300 may include an outer retaining ring groove 306, configured to mate with the retaining ring 703 during assembly. The upper fitting 300 may include a retaining ring compression taper 307, configured to compress the retaining ring 703 during assembly.

The upper fitting 300 may also include a third o-ring groove 308 configured to mate with a third o-ring 704 and to seal against a curled lip 101 of the aerosol can 100, as indicated in FIG. 3b.

Turning to FIG. 4, a crimp ring 400, configured to rest between the lower crimp ring seating surface 204, and the upper crimp ring seating surface 304, and configured to compressed in the axial direction (Y) while simultaneously expanding in the radial direction (X) during installation is presented.

Turning to FIG. 5, a second o-ring retainer 500, configured to seal against the second o-ring 702 during assembly is presented.

Turning to FIG. 6, a method of adapting a threaded connection 301 to an aerosol can 100 is presented. The aerosol can 100 may contain R134a. The method includes providing a lower fitting 200 including a central, axial opening 201, including a pin valve 202, a lower travel stop 203, and a lower crimp ring seating surface 204 (as described in FIG. 2a). The pin valve 202 may be a Schrader valve, or American valve. The pin valve 202 may be a Presta valve, Sclaverand valve, or French valve. The method includes providing an upper fitting 300 including a male thread 301, a seating radius 302 configured to conform with a curled lip 101 of the aerosol can 100, an upper travel stop 303, configured to contact the lower travel stop 203 during assembly, and an upper crimp ring seating surface 304 (as described in FIG. 3a). The male thread 301 may be compatible with a female CGA-600 connection.

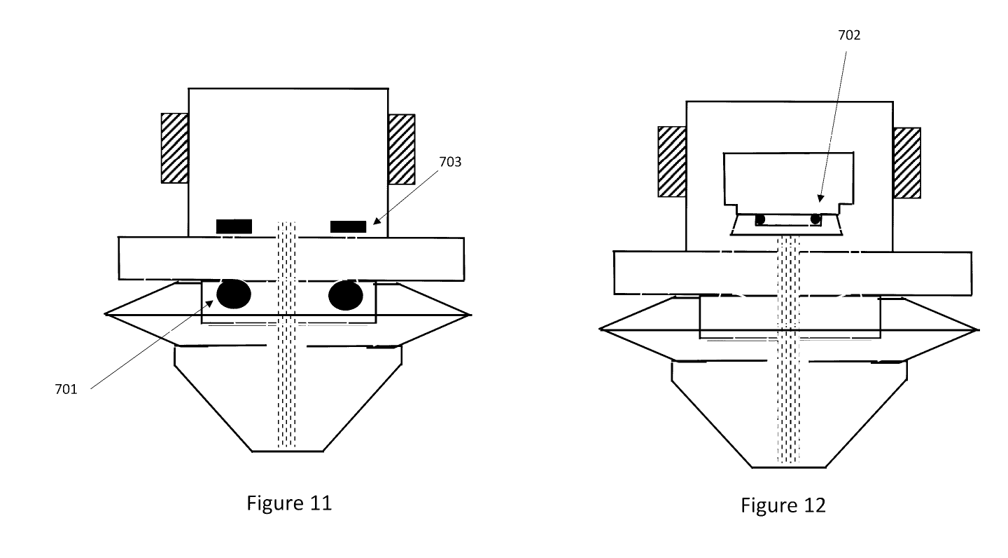

As described in FIGS. 2a, 3a, and 11, the lower fitting 200 may include an exterior first o-ring groove 206, configured to mate with a first o-ring, and providing an interior first o-ring sealing surface 305 on the upper fitting 300 configured to seal against the first o-ring 701 during assembly, thereby sealing the lower fitting 200 against the upper fitting 300.

The lower fitting 200 may include an inner retaining ring groove 208, configured to mate with a retaining ring 703, and the upper fitting 300 may include an outer retaining ring groove 306, configured to mate with the retaining ring 703 during assembly, thereby locking the lower fitting 200 to the upper fitting 300. The upper fitting 300 may include a retaining ring compression taper 307, configured to compress the retaining ring during assembly. As lower fitting 200 passes through upper fitting 300, the retaining ring 703 contacts retaining ring compression taper 307, thereby causing the retaining ring 703 to slightly compress into inner retaining ring groove 208. As the lower fitting 200 is fully inserted into upper fitting 300, the inner retaining ring grove 208 and outer retaining ring grove 306 become aligned, and retaining ring 703 snaps into place, securing both fittings together.

As described in FIGS. 2a, 5, and 12. the lower fitting 200 may include a second o-ring seat 207, configured to mate with a second o-ring 702, and a second o-ring retainer 500 , configured to seal against the second o-ring 702 during assembly, thereby sealing the lower fitting 300 against a device mating to the male thread 301.

As described FIGS. 1, 3a, and 8, the upper fitting 300 may include a third o-ring groove 308 configured to mate with a third o-ring 704 and to seal against a curled lip 101 of the aerosol can 100.

As described in FIGS. 4 and 6, the method also includes providing a crimp ring 400, configured to rest between the lower crimp ring seating surface 204 and the upper crimp ring seating surface 304. The method includes inserting the lower fitting 200 into the crimp ring 400 and the upper fitting 300, thereby forming an adaptor assembly 601.

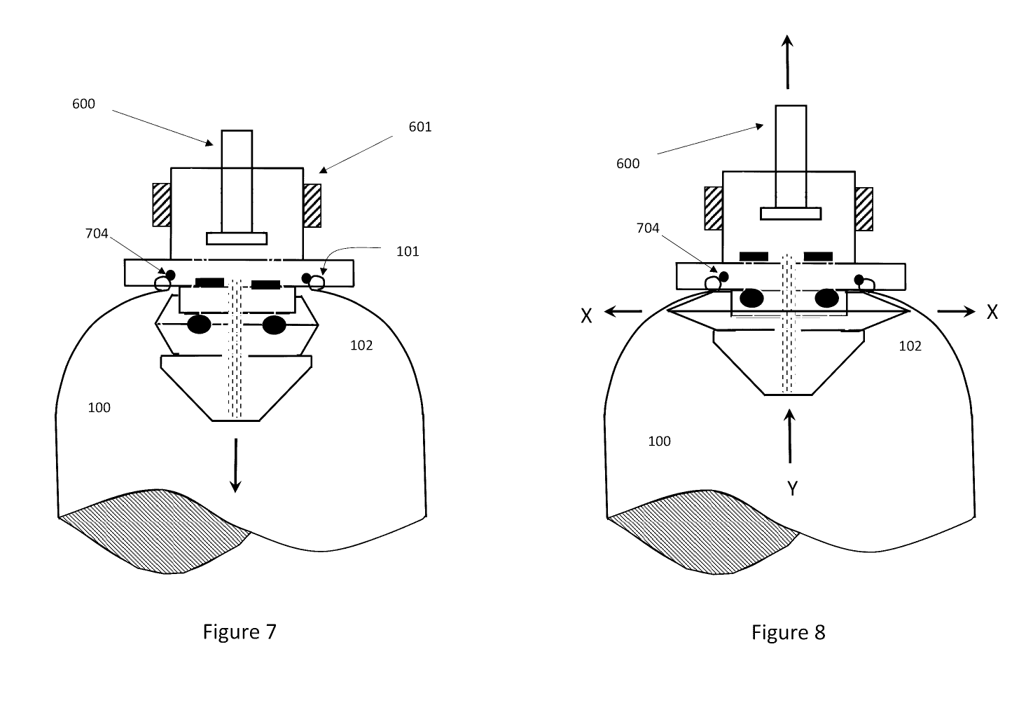

Turning to FIG. 7, the method includes inserting the adaptor assembly 601, lower fitting 200 end first, into the aerosol can 100, the aerosol can 100 comprising an inner surface 102.

Turning to FIG. 8, the method includes providing a pull-ring 205 which is configured to accept an assembly tool 600. The assembly tool 600 is used to pull the lower fitting 200 through the upper fitting 300, thereby compressing the crimp ring 400 in the axial (Y) direction while simultaneously expanding in the radial (X) direction. The expanded crimp ring 400 thereby makes contact with the inner surface 102 and fixedly installing the adaptor assembly in the aerosol can 100.

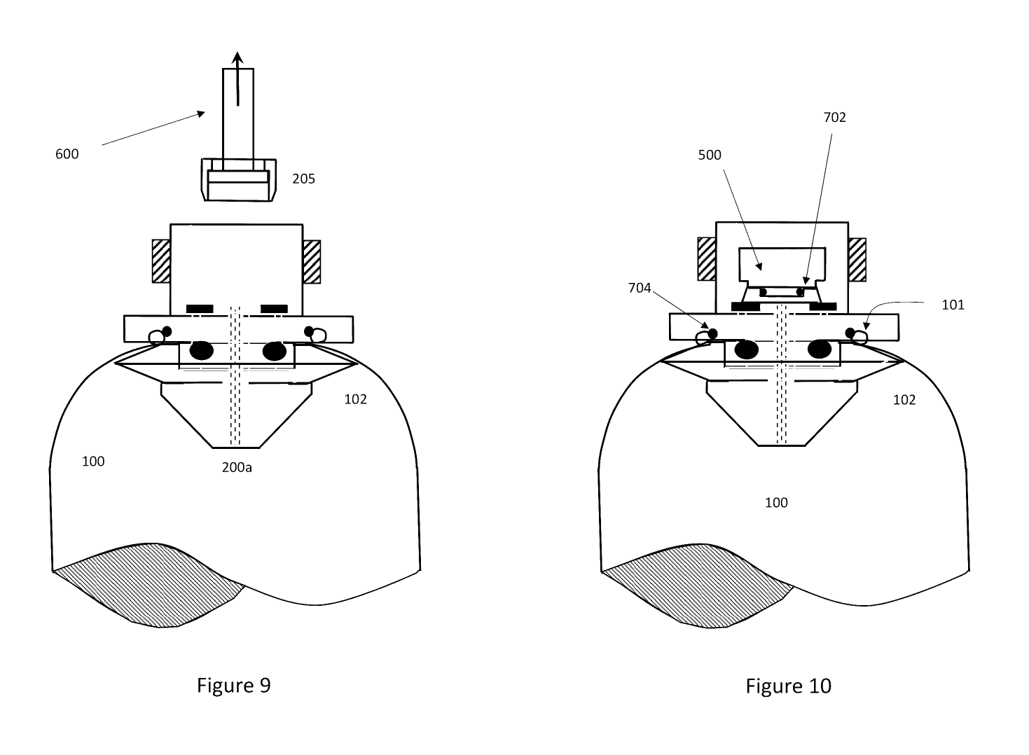

Turning to FIGS. 9, 10, and 12, upon completion of assembly, the pull-ring 205 is configured to shear away from the lower fitting 200a, and the second o-ring 702 and the second o-ring retainer 500 are installed.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A method of adapting a threaded connection (301) to an aerosol can (100), comprising:
providing a lower fitting (200) comprising:
a central, axial opening (201) comprising a pin valve (202),
a lower travel stop (203),
a lower crimp ring seating surface (204),
providing an upper fitting (300) comprising:
a male thread (301), and
a seating radius (302) configured to conform with a curled lip (101) of the aerosol can (100),
an upper travel stop (303), configured to contact the lower travel stop (203) during assembly, and an
an upper crimp ring seating surface (304),
providing a crimp ring (400), configured to rest between the lower crimp ring seating surface, (204) and the upper crimp ring seating surface (304),
inserting the lower fitting (200) into the crimp ring (400) and the upper fitting (300), thereby forming an adaptor assembly (601),
inserting the adaptor assembly (601), lower fitting (200) first, into the aerosol can (100), the aerosol can (100) comprising a inner surface (102),
pulling the lower fitting (200) through the upper fitting (300), thereby compressing the crimp ring (400) in the axial direction while simultaneously expanding in the radial direction, thereby making contact with the inner surface (102) and fixedly installing the adaptor assembly in the aerosol can (100).

2. The method of claim 1, further comprising providing a pull-ring (205) which is configured to accept an assembly tool (600), and which is configured to shear upon completion of assembly, and separate from the lower fitting (200a).

3. The method of claim 1, wherein the male thread (301) is compatible with a female CGA-600 connection.

4. The method of claim 1, further comprising:
providing an exterior first o-ring groove (206), configured to mate with a first o-ring, and
providing an interior first o-ring sealing surface configured to seal against the first o-ring during assembly, thereby sealing the lower fitting against the upper fitting.

5. The method of claim 1, further comprising;
providing a second o-ring seat, configured to mate with a second o-ring, and
providing a second o-ring retainer, configured to seal against the second o-ring during assembly, thereby sealing the lower fitting against a device mating to the male thread.

6. The method of claim 1, further comprising;
providing an inner retaining ring groove, configured to mate with a retaining ring, and
providing an outer retaining ring groove, configured to mate with the retaining ring during assembly, thereby locking the lower fitting to the upper fitting.

7. The method of claim 6, further comprising providing a retaining ring compression taper, configured to compress the retaining ring during assembly.

8. The method of claim 1, further comprising providing a third o-ring groove configured to mate with a third o-ring and to seal against a curled lip of the aerosol can.

9. The method of claim 1, wherein the aerosol can contains R134a.

10. The method of claim 1, wherein the pin valve is a Schrader valve.
